(19) United States
(12) Patent Application Publication
(10) Pub. No.: US 2011/0256744 A1
(43) Pub. Date: Oct. 20, 2011

(54) ELECTRICAL CONNECTOR HAVING DUST-PROOF DEVICE WITH SELF-DRIVEN ARRANGEMENT

(75) Inventor: ZHI-FENG WANG, Kunshan (CN)

(73) Assignee: HON HAI PRECISION INDUSTRY CO., LTD., New Taipei (TW)

(21) Appl. No.: 13/087,352

(22) Filed: Apr. 14, 2011

(30) Foreign Application Priority Data
Apr. 15, 2010 (CN) 201020159478.6

(51) Int. Cl. H01R 13/44

(52) U.S. Cl. 439/136

(57) ABSTRACT

An electrical connector includes an insulative housing, a plurality of contacts retained in the housing, a shell enclosing the housing and a dust-proof device. The dust-proof device defining a dust-proof member movable from a closed position to an open position, a resilient connecting member attached to the dust-proof member, and a pivoting portion connecting the dust-proof member with the shell by a shaft formed on the resilient connecting member running through the pivoting portion. A peak point is provided on the pivoting portion and disposed between a first position and a second position, and the dust-proof member will automatically return to the closed position when the shaft rotates between the first position and the peak point and automatically reach to the open position when the shaft rotates between the peak point and the second position.

### BACKGROUND OF THE INVENTION

1. Field of the Invention

The present invention relates to an electrical connector, and more particular to an electrical connector with a dust-proof member which can be properly positioned between an open position in which a plug can be readily inserted thereto, and a closed position when the plug is disengaged therefrom.

2. Description of the Related Art

Japanese Publication No. 6-331859, which was published before it was fully examined, discloses a connector having a door for preventing entering of dust. The connector includes an insulative housing having a mating face and a mating cavity facing toward the mating face thereof for receiving a mating connector therein. The mating cavity provides a mating opening at the mating face thereof, and the mating face defines a pair of retaining holes disposed at two sides of the mating opening. The door defines a pair of posts received in the corresponding retaining holes and a base portion for covering the mating opening. The post pivots in the retaining hole to make the base portion move from a closed position in which the base portion is positioned in front of the mating opening to an open position for permitting an insertion of the mating connector.

However, the door is preset at the closed position and users should pull the base portion so as to have the door arrived to the open position and hold the base portion stay therein until the mating connector is inserted into the mating cavity. Obviously, this operation is not convenient for users, and an electrical connector with dust-proof device which is easy and convenient for users to operate is highly desired.

### SUMMARY OF THE INVENTION

Accordingly, an object of the present invention is to provide an electrical connector having a movable dust-proof device which can automatically return to a closed position and reach to an open position.

In order to achieve the object set forth, an electrical connector includes an insulative housing, a plurality of contacts retained in the housing, a shell enclosing the housing and defining a mating cavity having a mating opening at a front end thereof, and a dust-proof device movably attached to the mating opening. The dust-proof device defines a dust-proof member movable between a closed position and an open position, a resilient connecting member attached to the dust-proof member, and a pivoting portion connecting the dust-proof member with the shell by a shaft formed on the resilient connecting member running through the pivoting portion. The shaft rotates along the pivoting portion between a first position in which the dust-proof member stays at the closed position and a second position in which the dust-proof member stays at the open position. A peak point is provided on the pivoting portion and disposed between the first position and the second position, and the dust-proof member will automatically return to the closed position when the shaft rotates between the first position and the peak point and automatically reach to the open position when the shaft rotates between the peak point and the second position.

Other objects, advantages and novel features of the invention will become more apparent from the following detailed description of the present embodiment when taken in conjunction with the accompanying drawings.

### BRIEF DESCRIPTION OF THE DRAWINGS

FIG. 1 is a perspective view of an electrical connector, showing a dust-proof device disposed in a closed position;

FIG. 2 is another perspective view of the electrical connector shown in FIG. 1, showing the dust-proof device disposed in an open position;

FIG. 3 is an exploded view of the electrical connector shown in FIG. 2;

FIG. 4 is another exploded view of the electrical connector shown in FIG. 3;

FIG. 5 is a front elevational view of the electrical connector shown in FIG. 2; and

FIG. 6 is a left side elevational view of a shell of the electrical connector shown in FIG. 3; and

FIG. 7 is an amplificatory portion in the circle A shown in FIG. 1.

### DETAILED DESCRIPTION OF THE INVENTION

Reference will now be made to the drawing figures to describe preferred embodiments of the present invention in detail.

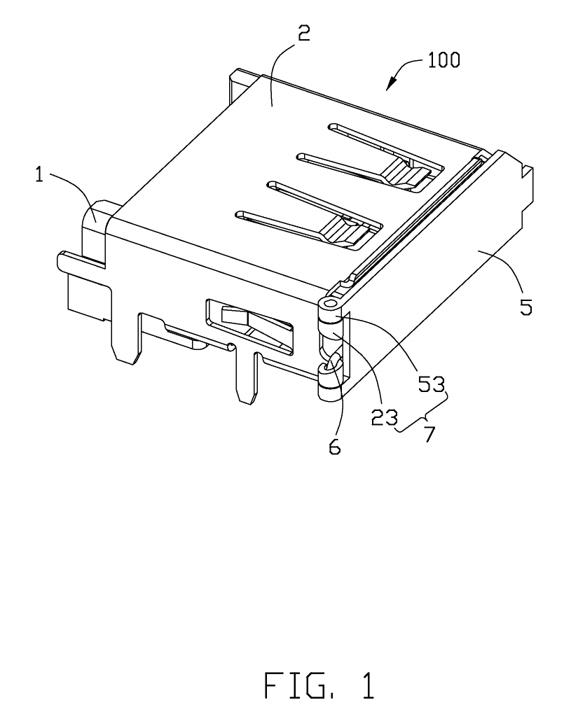

Referring to FIG. 1 to FIG. 4, the electrical connector 100 described in this preferred embodiment includes an insulative housing 1, a metal shell 2 enclosing the housing 1, a plurality of contacts 3 retained in the housing 1, a spacer 4 assembled to the housing 1, a dust-proof member 5 connecting with the shell 2, and a resilient connecting member 6 attached to the dust-proof member 5.

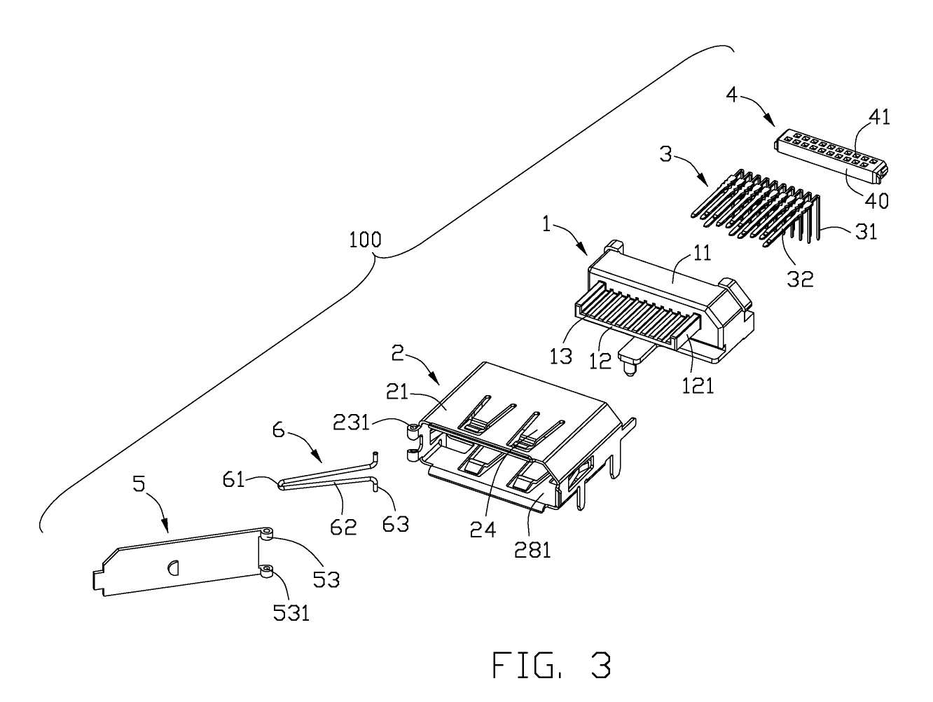

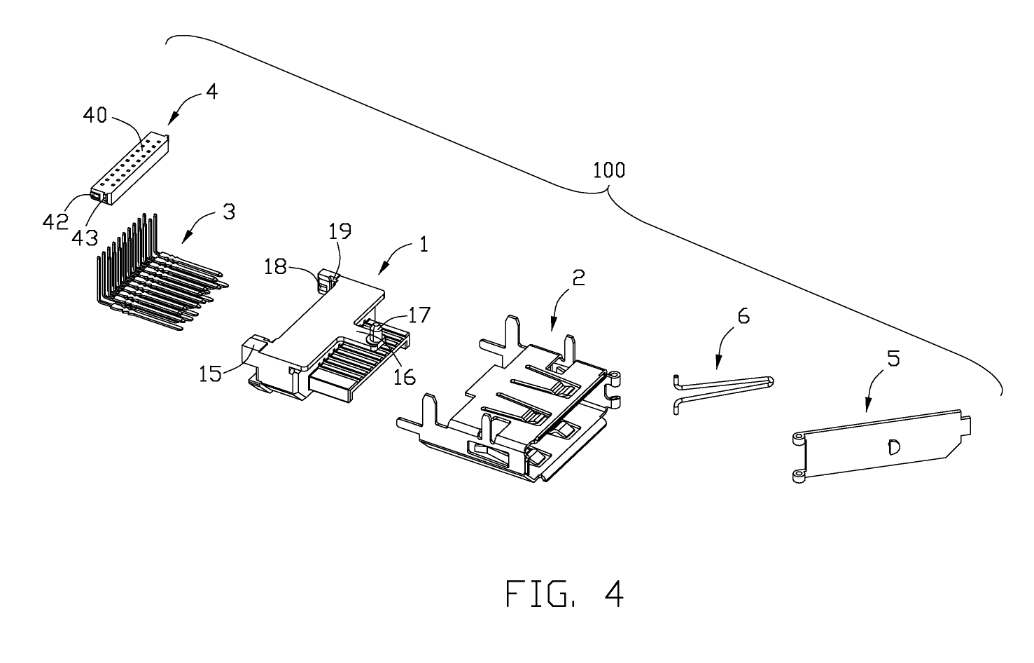

Referring to FIG. 3 and FIG. 4, the housing 1 defines a rectangular base portion 11 and a mating portion 12 extending forwardly along a mating direction from the base portion 11. The mating portion 12 defines a plurality of passageways 13 recessed from opposite top and bottom faces thereof and running through the base portion 11, and two protrusions 121 respectively upwardly extending from two sides of mating portion 12 for preventing an insertion of an incorrect mating connector. The base portion 11 provides a fixing board 16 extending forwardly from a middle portion thereof, the fixing board 16 is parallel to the mating portion 12 and disposed under the mating portion 12. The fixing board 16 defines a post 17 extending downwardly for attaching to a printed circuit board to retain the electrical connector 100 onto the printed circuit board steadily. A pair of retaining arms 15 oppositely extends rearwards from two sides of the base portion 11 at a lower portion thereof, and each retaining arm 15 defines a guiding slot 19 recessed from an inner surface thereof and a locking slot 18 disposed behind the guiding slot 19. The guiding slot 19 extends perpendicularly to the mating direction.

The contacts 3 are arranged in upper and lower rows to be disposed in the corresponding passageways 13. Each of the contacts 3 defines a contacting arm 32 retained on the mating portion 12 and a soldering portion 31 bending from the contacting arm 32 and extending out of the housing 1. The contacting arms 32 disposed at two opposite sides of the mating portion 12. The spacer 4 defines a rectangular main body portion 40 and a plurality of through holes 41 running through the main body portion 40. The spacer 4 is upwardly assembled to the housing 1, the soldering portions 31 pass through the through holes 41, and guiding portions 43 disposed at two sides of the main body portion 40 align with the corresponding guiding slot 19. The guiding portion 43 downwardly slides along the guiding slot 19 until a locking protrusion 42 locked into the locking slot 18, and the guiding portion 43 retained in the guiding slot 19. The spacer 4 is retained between the retaining arms 15.

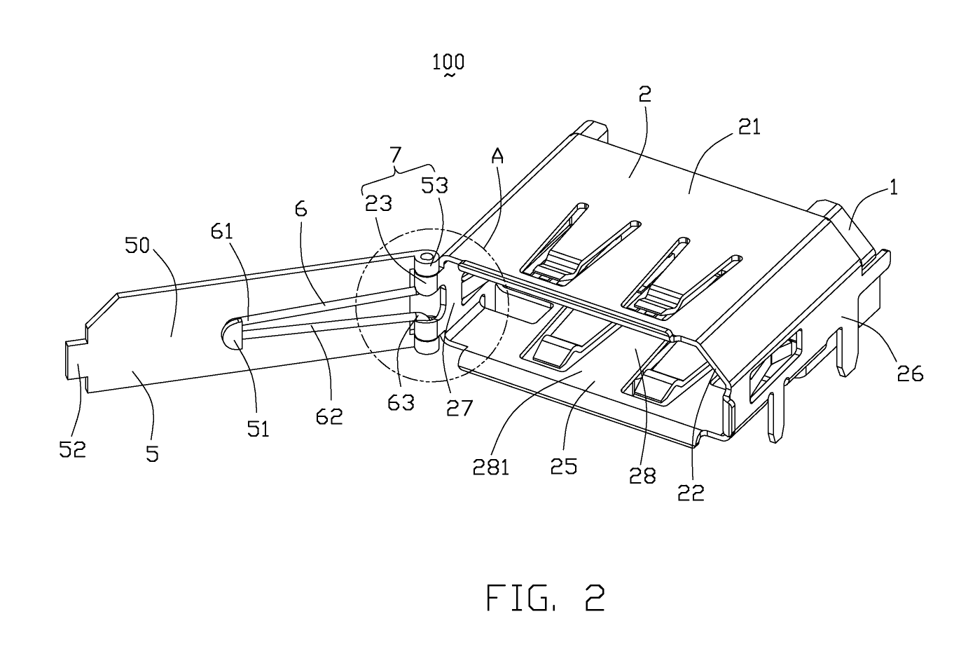

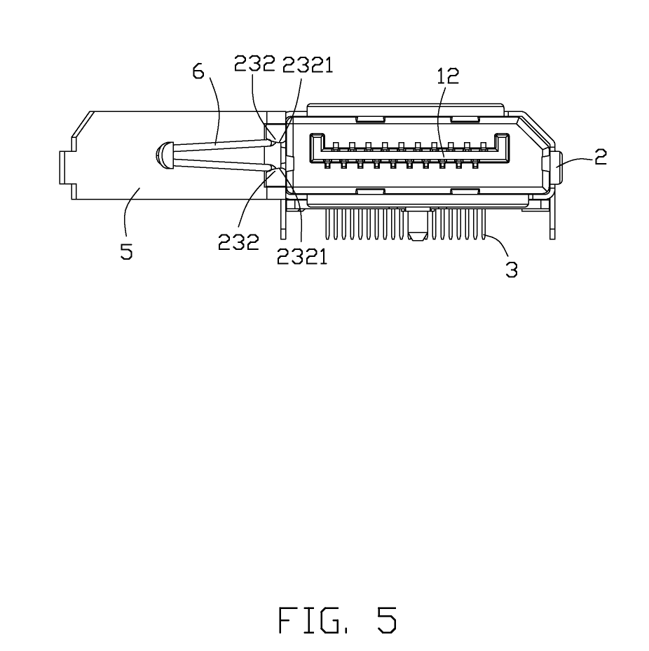

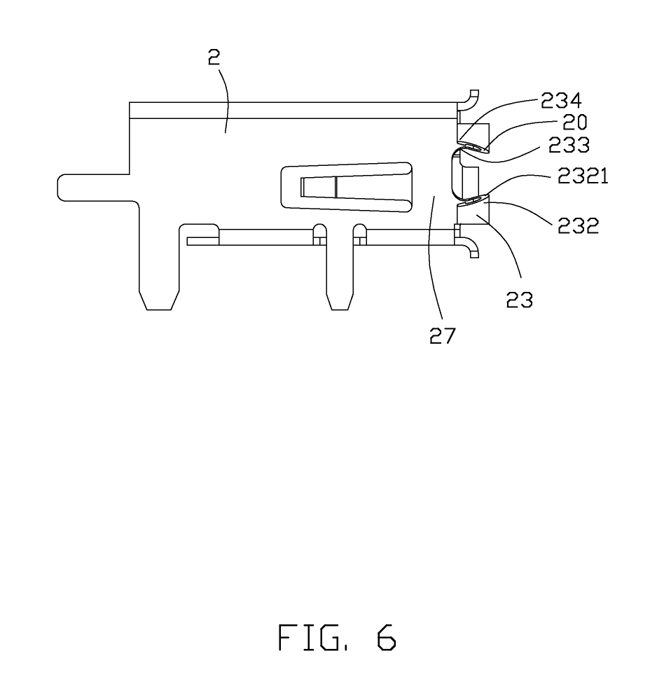

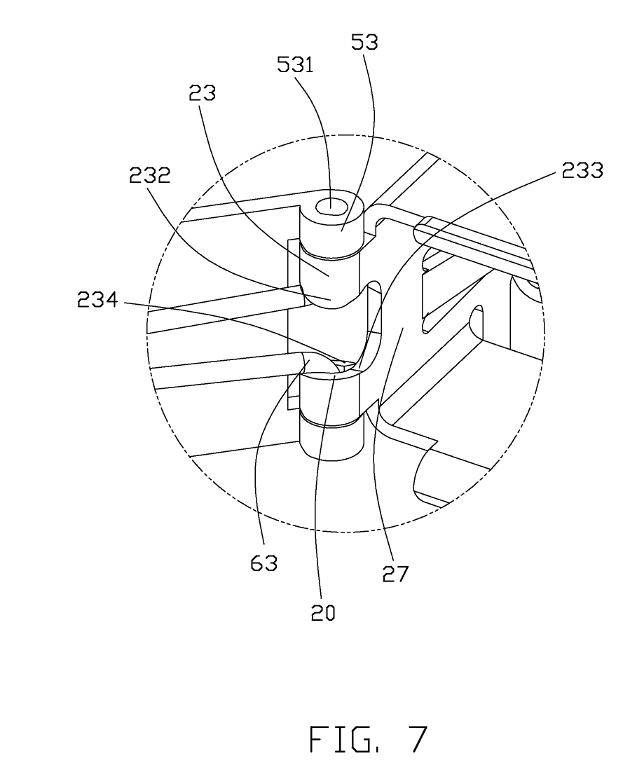

Referring to FIG. 2 to FIG. 7, the shell 2 defines a top piece 21, a bottom piece 25 opposite to the top piece 21, a first side piece 27 connecting with the top and bottom pieces 21, 25, a second side piece 26 opposite to the first side piece 27 and a mating cavity 28 formed by the top piece 21, the bottom piece 25, the first side piece 27 and the second side piece 26 commonly. The mating cavity 28 defines a mating opening 281 at a front end thereof. The board-shaped first side piece 27 vertically connects the top piece 21 and the bottom piece 25, and the second side piece 26 defines a connecting piece 22 extending slantways toward the top piece 21 and connecting with the top piece 21, which makes the mating opening 281 of the shell 2 have a function for preventing an insertion of an incorrect mating connector. The top piece 21, the bottom piece 25, the first side piece 27 and the second side piece 26 each defines at least one latching arm 24 projecting into the mating cavity 28 for latching with a mating connector. The first side piece 27 defines a pair of retaining portions 23 extending outwards from a front side edge thereof, the two retaining portions 23 are spaced from each other and opposite to each other. Each retaining portion 23 curls outwards to form a columned shape and providing a receiving hole 231 at a middle portion thereof. The retaining portion 23 defines a first recessing portion 233 at a joint of the retaining portion 23 and the first side piece 27, and a second receiving portion 234 at a free end of the retaining portion 23. Each of the two retaining portions 23 defines a protrusion portion 232 disposed between the first recessing portion 233 and the second receiving portion 234, and the two protrusion portions 232 project toward each other. Each of the two protrusion portions 232 provides an arc-shaped supporting face 20 along the retaining portion 23, and the two supporting faces 20 face to each other. Each of the protrusion portions 232 provides a peak point 2321 disposed between the first recessing portion 233 and the second receiving portion 234 on the supporting face 20 thereof, and the two opposite supporting faces 20 provide a shortest distance between the opposite peak points 2321. The distance between the two opposite supporting faces 20 is crescent at two sides of the two opposite peak points 2321, both along from the peak point 2321 to the first recessing portion 233 and along from the peak point 2321 to the second receiving portion 234.

Referring to FIG. 2 and FIG. 3, the dust-proof member 5 defines a board-shaped covering portion 50, an operating portion 52 extending from a front edge of the covering portion 50 and a pair of joint portions 53 disposed at a rear edge of the covering portion 50. The covering portion 50 defines a locking portion 51 projecting from a side face thereof. The two joint portions 53 are spaced from each other and each is of a columned shaped with a retaining holes 531 disposed at a middle portion thereof. The resilient connecting member 6 bends from a metal pole and defines an arc shaped connecting portion 61, two opposite resilient arms 62 slantways extending from two free ends of the connecting portion 61 and two shafts 63 each bending from a free end of the resilient arm 62. The two shafts 63 extend away from each other. During assemblage, the joint portions 53 are disposed at two outer side of the corresponding retaining portions 23 with the retaining holes 531 aligning with the receiving hole 231, the connecting portion 61 is retained to the locking portion 51, and the shaft 63 runs through the receiving hole 231 and into the retaining holes 531 to connect the dust-proof member 5 with the shell 2. The dust-proof member 5 together with the resilient connecting member 6 and the retaining portions 23 are defined as a dust-proof device. The joint portions 53 attach to the retaining portions 23 to define a pivoting portion 7 of the dust-proof device. The pivoting portion 7 connects the dust-proof member 5 with the shell 2 by the shafts 63 running through the pivoting portion 7. The dust-proof member 5 rotates around the pivoting portion 7 between a closed position in which the covering portion 50 covering the mating opening 281 and an open position in which the covering portion 50 is kept away from the mating opening 281 and the mating connector can be readily inserted thereto. Each shaft 63 is disposed at a first position when the dust-proof member 5 stays at the closed position, and is disposed at a second position when the dust-proof member 5 stays at the open position. The shaft 63 rotates between the first position and the second position along the supporting face 20 of the retaining portions 23, and the peak point 2321 is disposed between the first position and the second position. The shaft 63 is received in the first recessing portion 233 when which is disposed at the first position. The pivoting portion 7 is defined to include two cams projecting to each other, and first and second valleys spared with each of the cams, and the resilient arms are rested either in the first or the second valley.

When the operating portion 52 is pulled to make the dust-proof member 5 move away from the closed position, each shaft 63 rotates along the corresponding supporting face 20 from the first position toward the peak point 2321 and is pressed by the corresponding protrusion portion 232, the opposite resilient arms 62 move inwardly to be deflected, and the resilient connecting member 6 has the largest deflection when the shafts 63 disposed between the opposite peak points 2321. When the shafts 63 do not surpass the peak portions 2321, the resilient connecting member 6 will revert to drive the dust-proof member 5 to return to the closed position, while if the shafts 63 surpasses the peak points 2321, the resilient connecting member 6 will revert to make the shafts 63 rotate towards the second position and drive the dust-proof member 5 reach to the open position. The dust-proof member 5 will automatically return to the closed position when the shafts 63 rotates between the first position and the peak points 2321, which can prevent the dust-proof member 5 from being opened accidentally. The dust-proof member 5 will automatically reach to the open position when the shafts 63 rotate between the peak points 2321 and the second position. On other wards, the dust-proof member 5 will automatically reach to the open position if users pull the dust-proof member 5 until the shafts 63 surpass the peak points 2321 and disposed between the peak points 2321 and the second position, and will automatically return to the closed position if users push the dust-proof member 5 until the shafts 63 surpass the peak points 2321 and disposed between the peak points 2321 and the first position, which makes the operating of the dust-proof device easy and convenient.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An electrical connector comprising:
an insulative housing;
a plurality of contacts retained in the housing;
a shell enclosing the housing and defining a mating cavity having a mating opening at a front end thereof; and
a dust-proof device movably attached to the mating opening and defining a dust-proof member movable between a closed position and an open position, a resilient connecting member attached to the dust-proof member, and a pivoting portion connecting the dust-proof member with the shell by a shaft formed on the resilient connecting member running through the pivoting portion, the shaft rotating along the pivoting portion between a first position in which the dust-proof member stays at the closed position and a second position in which the dust-proof member stays at the open position;
wherein a peak point is provided on the pivoting portion and disposed between the first position and the second position, and the dust-proof member will automatically return to the closed position when the shaft rotates between the first position and the peak point and automatically reach to the open position when the shaft rotates between the peak point and the second position.

2. The electrical connector as described in claim 1, wherein the pivoting portion defines a protrusion portion disposed between the first position and the second position, the peak point is defined on the protrusion portion.

3. The electrical connector as described in claim 2, wherein the protrusion portion defines a supporting face thereof, the shaft rotates along the supporting face and the peak point is disposed on the supporting face.

4. The electrical connector as described in claim 3, wherein the pivoting portion defines two opposite retaining portions extending from the shell, the pivoting portion defines two protrusion portions respectively extending from the two retaining portions and projecting to each other, the two protrusion portions provide two supporting faces facing to each other.

5. The electrical connector as described in claim 4, wherein the two opposite supporting faces provide a shortest distance between the opposite peak points, and the distance between the two opposite supporting faces is crescent at two sides of the two opposite peak points.

6. The electrical connector as described in claim 5, wherein the resilient connecting member defines two shafts respectively rotating along the two supporting faces.

7. The electrical connector as described in claim 6, wherein the pivoting portion further defines a pair of joint portions extending from the dust-proof member and respectively disposed at two outer sides of the retaining portions, the shafts each run through the corresponding retaining portion and into the joint portion.

8. The electrical connector as described in claim 6, wherein the resilient connecting member defines two resilient arms spaced from each other, and the two shafts each is bent from a free end of the resilient arm.

9. The electrical connector as described in claim 8, wherein the resilient connecting member defines a connecting portion connecting with the two resilient arms and attached to the dust-proof member.

10. The electrical connector as described in claim 4, wherein the housing defines a base portion and a mating portion extending from the base portion, the contacts defines contacting arms disposed at two opposite sides of the mating portion.

11. The electrical connector as described in claim 10, wherein the mating portion defines a protrusion upwardly extending from a side thereof.

12. An electrical connector comprising:
a shell defining a mating cavity with a contact insert disposed therein; and
a dust-proof device attached to the mating cavity by a pivoting portion which including first and second valleys spared with a cam, and a resilient connecting member with at least a resilient arm biasing toward the dust-proof device and rested either in the first or the second valley.

13. The electrical connector as described in claim 12, wherein the pivoting portion defines two cams projecting to each other, and the resilient connecting member defines two resilient arms spaced from each other and disposed between the two cams.

14. The electrical connector as described in claim 13, wherein the two cams provide two supporting faces facing to each other, and the resilient connecting member defines two shafts each bent from a free end of the resilient arm and rotating along the two supporting faces.

15. The electrical connector as described in claim 14, wherein the resilient connecting member defines a connecting portion connecting with the two resilient arms and attached to the dust-proof device.

16. An electrical connector assembly comprising:
a connector unit including at least an insulative housing and a plurality of contacts disposed in the housing with contacting sections exposed in a mating port which is confined by a plurality of faces and is adapted to forwardly communicates with an exterior; and
a dust-proof device pivotally mounted to an edge region of one of said faces and adapted to be rotated between a farther open position, where the dust-proof device exposes the mating port, and a nearer closed position, where the dust-proof device covers the mating port; wherein
complementary interengaging devices are formed on both the dust-proof device and the connector unit so as to assure unless an external intentional withdrawal force is applied to the dust-proof device for moving the dust-proof device from the closed position to the open position, said dust-proof device is able to be delicately retained to the connector unit at the closed position without risk of incautious exposure of the mating port to the exterior.

17. The electrical connector assembly as claimed in claim 16, wherein said complementary interengaging devices are formed on a hinge portion between the dust-proof device and the connector unit.

18. The electrical connector assembly as claimed in claim 17, wherein said hinge portion defines an axis extending along a vertical direction with regard to the exterior.

19. The electrical connector assembly as claimed in claim 17, wherein the connector unit further includes a metallic shell enclosing the insulative housing, said a plurality of faces are formed by said metallic shell, and the hinge portion is formed between the dust-proof device and the metallic shell.

20. The electrical connector assembly as claimed in claim 16, wherein a spring mechanism is provide between the dust-proof device and the edge region which at least initially opposes withdrawal of the dust-proof device from the closed position to the open position.
